(19) United States
(12) Patent Application Publication
(10) Pub. No.: US 2023/0014143 A1
(43) Pub. Date: Jan. 19, 2023

(54) COOKING DEVICE

(71) Applicant: SHANGHAI CHANGSHAN INTELLIGENT TECHNOLOGY CORPORATION LIMITED, Shanghai (CN)

(72) Inventors: Xinlei HUA, Shanghai (CN); Tao SHEN, Shanghai (CN)

(21) Appl. No.: 17/633,566

(22) PCT Filed: Aug. 6, 2020
(86) PCT No.: PCT/CN2020/107394

§ 371 Date: Oct. 6, 2022

(30) Foreign Application Priority Data
Aug. 6, 2019 (CN) 201910720189.4

(51) Int. Cl. A47J 36/32; A47J 44/00; A47J 27/00

(52) U.S. Cl. CPC A47J 36/32; A47J 44/00; A47J 27/002

(57) ABSTRACT

A cooking device (10). The cooking device (10) comprises: a cooking unit (200), which is configured to cook food ingredients; and an ingredient feeding device (100), which is located above the cooking unit (200). The ingredient feeding device (100) is connected to the cooking unit (200) by a feeding port (140); the ingredients can enter the cooking unit (200) from the ingredient feeding device through the feeding port (140). The ingredient feeding device (100) comprises: a rotary mechanism (110), the side surface of the rotary mechanism (110) being provided with at least one storage box (120), the rotary mechanism (110) being driven to rotate about a rotary axis to enable a predetermined storage box (120) to rotate from a non-feeding position which deviates from the feeding port (140) to a feeding position aligned with the feeding port (140), and a separator (122) being provided at the bottom of the storage box (120); and a separator actuating device (130), configured to enable the separator (122) to move from a holding position for blocking the ingredients from falling off to a release position for allowing the ingredients to fall off.

### TECHNICAL FIELD

This application relates to a cooking device, and more specifically, to an automated cooking device.

### BACKGROUND

With the continuous acceleration of the pace of life in modern society and the continuous enhancement of urban agglomeration effects, people's demand for fast and efficient large-scale supply of stable quality meals continues to increase. Manual cooking is time-consuming and laborious, and the quality of the dishes is difficult to maintain stable. In this case, automated cooking equipment came into being.

However, although cooking equipment on the market can partially replace labor, the existing cooking equipment still needs to be manually controlled by the operator to put ingredients into the cooking equipment before each cooking, which cannot meet the demand for rapid and large-scale supply of finished dishes. In addition, the operator may be overwhelmed and error-prone when food needs to be served quickly.

### SUMMARY

An object of the present application is to provide an improved cooking device, which can realize the automatic delivery of ingredients, thereby improving the working efficiency, intelligence and automation of the cooking device.

In one aspect of the present application, a cooking device is disclosed, the cooking device comprising: a cooking unit configured to perform cooking processing on ingredients; and an ingredient feeding device, the ingredient feeding device being located above the cooking unit; the ingredient delivery device and the cooking unit are in communication with each other through a feeding port, and food can enter the cooking unit from the ingredient delivery device through the feeding port. The ingredient delivery device includes a rotating mechanism, at least one storage box is provided on the side of the rotating mechanism, and the rotating mechanism can be driven to rotate around a rotation axis so that a predetermined one of the storage boxes deviates from the non-feeding position of the feeding port is rotated to the feeding position aligned with the feeding port, the bottom of the storage box is provided with a partition; and a partition activating device, the partition activating device is configured to activate the corresponding the partition to move from a blocking position that prevents the ingredient from falling to a release position that allows the ingredient to fall.

Another aspect of the present application discloses a cooking device, the cooking device comprising: a cooking unit configured to perform cooking processing on ingredients; and an ingredient feeding device, the ingredient feeding device being located above the cooking unit, the ingredient feeding device is capable of connecting to the cooking unit through a feeding port, and food ingredient can enter the cooking unit from the ingredient feeding device through the feeding port; the ingredient feeding device includes: an integrated storage box, the integrated storage box includes at least two bins for separately storing ingredient a holding device for the integrated storage box, wherein the integrated storage box can be slid into the holding device; a rotating mechanism, the storage box holding device is detachably mounted to the rotating mechanism, and the storage box holding device can be driven by the rotating mechanism to rotate around the axis so that a predetermined ingredient bin in the integrated storage box is rotated from a non-feeding position deviated from the feeding port to a feeding position aligned with the feeding port; and a partition actuating device, the partition actuating device is configured to drive the corresponding partition to move from the blocking position where the ingredient is prevented from falling to the release position where the ingredient is allowed to fall.

In some embodiments of the present application, the partition is pivotally fixed to the bottom of the storage box.

In some embodiments of the present application, the partition is pivotally fixed to the bottom of each bin in the integrated storage box.

In some embodiments of the present application, the partition actuating device includes a partition support member set at the bottom of the storage box or at the bottom of the corresponding bins and configured to support the free end of the partition to be either in the first position, holding the food ingredient, or in the second position where the free end of the partition is released, letting the food ingredient to fall.

In some embodiments of the present application, the partition actuating device further includes a driving member configured to drive the partition support member to move from the first position to the second position.

In some embodiments of the present application, the partition support member is connected to the storage box or the bins within by an elastic member, and the elastic member applies a bias force to the partition support member so that it stays in the first position.

In some embodiments of the present application, the partition actuating device further includes a guide rail for guiding the movement of the driving member.

In some embodiments of the present application, the driving member is driven by a stepper motor.

In some embodiments of the present application, the driving member includes an electromagnet, and the partition support member is provided with a magnetic conductive member that can be magnetically combined with the electromagnet.

In some embodiments of the present application, one of the driving member and the partition supporting member is provided with a groove, and the other is provided with a protrusion that mechanically cooperates with the groove.

In some embodiments of the present application, one of the driving member and the partition support member has a hook portion, and the other has a pull loop that cooperates with the hook portion.

In some embodiments of the present application, the cooking device includes a plurality of stacked storage boxes.

In some embodiments of the present application, the bottom edge of each storage box shrinks inwardly, so that the bottom edge of the storage box can be received by the top edge of the storage box below it.

In some embodiments of the present application, the rotating mechanism is configured as a polygonal column, and at least one storage box is provided on each side of the polygonal column.

In some embodiments of the present application, the rotating mechanism is configured as a hexagonal column, wherein at least two side-by-side auxiliary ingredient storage boxes are arranged on one side of the rotating mechanism, and at least two auxiliary ingredient storage boxes are arranged on each of the remaining five sides. One of the storage boxes.

In some embodiments of the present application, the center of the storage box holding device is provided with a hole cooperating with the rotating mechanism.

In some embodiments of the present application, multiple storage boxes are constructed as an integral part.

In some embodiments of the present application, multiple storage boxes are physically combined to form an integrated storage box with multiple bins.

In some embodiments of the present application, the integrated storage box includes four bins, each can hold different ingredient.

In some embodiments of the present application, the storage box is detachably mounted to the rotating mechanism.

In some embodiments of the present application, a card slot is provided on the side of the rotating mechanism, and a protrusion is provided on the side wall of the storage box, and the protrusion is detachably matched with the card slot to support the storage box.

In some embodiments of the present application, the inner surface of the storage box and/or the upper surface of the partition is provided with a number of small protrusions.

In some embodiments of the present application, a baffle plate is provided between the rotating mechanism and the cooking unit, and the baffle plate is configured to be switchable between a shielding position that shields the feeding port and opening position that exposes the feeding port.

In some embodiments of the present application, the baffle is configured to move linearly or rotate between the shielding position and the open position.

In some embodiments of the present application, a detachable receiving tray is provided at the bottom of the rotating mechanism, and the receiving tray is configured to collect drips from a storage box or an ingredient bin in a non-feeding position.

In some embodiments of the present application, the cooking device further has an ingredient identification device configured to recognize the ingredient stored in the storage box or the corresponding bins.

In some embodiments of the present application, the ingredient identification device is mounted approximately at the top of the rotating mechanism.

In some embodiments of the present application, the ingredient identification device includes a wide-angle camera.

In some embodiments of the present application, the cooking device further includes a liquid ingredient feeding device, the liquid ingredient feeding device includes: a housing, the housing is provided with a first joint; a liquid tank placed in the housing, the liquid tank is provided with a second joint for receiving liquid, the second joint is detachably in fluid communication with the first joint; The first joint and the feeding pipe of the cooking unit; and a pump member connected to the feeding pipe, the pump member being configured to apply a negative pressure to the feeding pipe so that the liquid ingredient can flow in the feeding pipeline.

In some embodiments of the present application, one of the first joint and the second joint is a tapered male joint, and the other is a tapered female joint that matches the tapered male joint.

In some embodiments of the present application, the cooking device further includes: a pipe switching member connected to the feeding pipe, and the pipe switching member is configured to enable the cooking unit to selectively interact with the liquid tank or water source.

In some embodiments of the present application, the cooking device further includes a communication module, and the communication module can communicate with a server to receive a recipe from the server.

In some embodiments of the present application, the rotating mechanism is driven by a stepper motor.

In some embodiments of the present application, the cooking device further includes a controller configured to control the operation of the cooking device according to the recipe received from the server.

In the cooking device according to the present application, the storage box containing the ingredients can be driven by the rotating mechanism to move from the non-feeding position to the feeding position, and the partition at the bottom of the storage box, or at bottom of the bins within a storage box, is further driven by the partition activating device to the release position so the ingredients can be fed into the cooking unit without manual intervention, improving human efficiency.

The above is an overview of the application, and may be simplified, summarized and omitted in detail. Therefore, those skilled in the art should recognize that this part is only illustrative and is not intended to limit the scope of the application in any way. This summary is neither intended to determine the key features or essential features of the claimed subject matter, nor is it intended to be used as an auxiliary means to determine the scope of the claimed subject matter.

### BRIEF DESCRIPTION OF THE DRAWINGS

The above and other features of the content of this application will be more fully understood through the following description and appended claims in combination with the drawings. It can be understood that these drawings only depict several embodiments of the content of this application, and should not be considered as limiting the scope of the content of this application. By referring to the drawings, the content of this application will be explained more clearly and in detail.

FIG. 1 shows a schematic diagram of a cooking device 10 according to an embodiment of the present application;

FIG. 2 shows a schematic diagram of the ingredient feeding device 100 according to an embodiment of the present application;

FIG. 3 exemplarily shows a side view of the ingredient feeding device 100 and the ingredient identification device 170 shown in FIG. 2;

FIG. 4A shows a schematic diagram of the storage box 120 according to an embodiment of the present application in a stacked state; FIG. 4B shows an exploded diagram of two of the stacked storage boxes 120 shown in FIG. 4A; FIG. 4C shows a schematic diagram of the backside structure of the single storage box 120 shown in FIG. 4A;

FIG. 5A-5B exemplarily show the process of combining and moving the partition support member 132 by the driving member 133 according to an embodiment of the present application, wherein the partition 122 is in the blocking position in FIG. 5A and the driving member 133 has not yet combined the partition support member 132, and in FIG. 5B, the driving member 133 is combined with the partition support member 132 and moves the partition support member 132 to release the support of the partition 122, so that the partition 122 is in the release position;

FIG. 6A shows a schematic diagram of the baffle 150 and the receiving tray 160 according to an embodiment of the present application, in which the baffle 150 is in the shielding position, and the receiving tray 160 is in the installed state;

FIG. 6B shows a schematic diagram of the baffle 150 and the receiving tray according to an embodiment of the present application, where the baffle 150 is in an open position, and the receiving tray 160 is in a disassembled state;

FIG. 7A-7B show schematic diagrams of the baffle 150 according to some embodiments of the present application, wherein the baffle 150 in FIG. 7A is in the shielding position, and the baffle 150 in FIG. 7B is in the open position;

FIG. 8 shows a schematic diagram of a liquid ingredient feeding device 300 according to an embodiment of the present application;

FIG. 9A-9B respectively exemplarily show the connection state and the disassembly state of the liquid tank 304 of the liquid ingredient feeding device 300 shown in FIG. 8;

FIG. 10A-10B respectively exemplarily show enlarged schematic diagrams of the first joint 311 and the second joint 341 shown in FIGS. 9A-9B in the connected state and the disconnected state;

FIG. 11 shows a schematic diagram of a liquid ingredient supply pipeline switching member 305 according to an embodiment of the present application;

FIG. 12 shows a cooking flowchart of the cooking device 10 according to an embodiment of the present application;

FIG. 13A shows a top view of the integrated storage box 120′ with four bins according to a modification of the present application; FIG. 13B shows a bottom view of the integrated storage box 120 shown in FIG. 13A;

FIG. 14A-14B show a schematic bottom view of a drawer type storage box according to an embodiment of the present application, in which the integrated storage box 125 is pulled out of the storage box holding device 126 in FIG. 14A, and in FIG. 14B, the integrated The storage box 125 is completely inserted into the storage box holding device 126; FIG. 14C-14D show a schematic diagram of the state in which the storage box holding device and the integrated storage box 125 shown in FIG. 14B are turned over, wherein in FIG. 14C, the integrated storage box 125 is slightly pulled out of the storage box holding device 126, In FIG. 14D, the integrated storage box 125 is completely inserted into the storage box holding device 126.

### DETAILED DESCRIPTION

In the following detailed description, reference is made to the drawings that constitute an integral part of the application. In the drawings, unless the context indicates otherwise, the same symbols represent the same components. The illustrative embodiments described in the detailed description, drawings, and claims are not meant to be limiting. Without departing from the spirit or scope of the subject matter of the present application, other embodiments may be adopted, and other changes may be made. It can be understood that various aspects of the content of the application generally described in the application and illustrated in the drawings can be configured, replaced, combined, and designed with various different configurations, and all of these clearly constitute part of the content of the application.

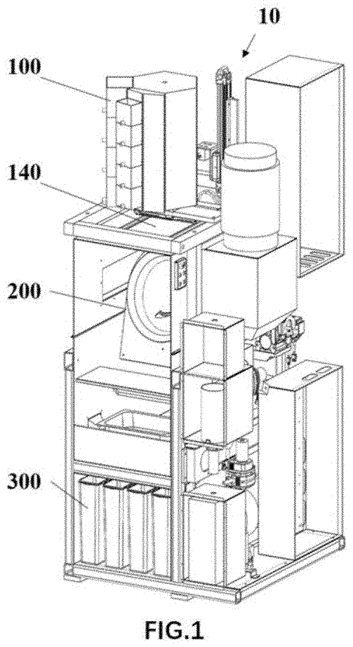

FIG. 1 shows a schematic diagram of a cooking device 10 according to an embodiment of the present application.

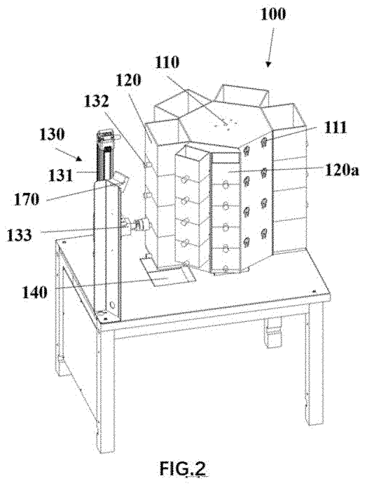

As shown in FIG. 1, the cooking equipment 10 mainly includes an ingredient feeding device 100, a cooking unit 200, and a liquid ingredient feeding device 300. Among them, the ingredient feeding device 100 can receive and store the food. The ingredient feeding device 100 is located above the cooking unit 200. The ingredient feeding device 100 and the cooking unit 200 are connected to each other through the feeding port 140 (FIG. 2). The ingredient feeding device 100 can automatically feed ingredients into the cooking unit 200 located below the feeding port 140 to perform a cooking operation. The specific structure and effects of the ingredient feeding device 100 will be described in detail below. The cooking unit 200 receives the ingredients from the ingredient feeding device 100 and performs cooking processing on the ingredients according to a predetermined program to finally obtain a dish. The liquid ingredient dispensing device 300 is used to deliver liquid ingredients to the cooking unit 200 during the cooking process. The ingredient feeding device 100, the cooking unit 200, and the liquid ingredient feeding device 300 can all be communicatively connected with a controller (not shown) and controlled by the controller. The cooking device 10 further includes a communication module, and the communication module can communicate with a server to receive a recipe from the server. The controller may obtain and store the ingredient information stored in the ingredient placing device 100. Based on the obtained recipe and food information, the controller controls the ingredient feeding device 100 to deliver the required food and seasonings to the cooking unit 200 according to a predetermined cooking program, and controls the cooking unit 200 to process the received ingredient to finally obtain the predetermined dishes.

FIG. 2 shows a schematic diagram of an ingredient feeding device 100 according to some embodiments of the present application. As shown in FIG. 2, the food placing device 100 includes a rotating mechanism 110. At least one storage box 120 is provided on the side of the rotating mechanism 110. In the embodiment shown in FIG. 2, the rotating mechanism 110 is configured in a hexagonal column shape, and a plurality of storage boxes 120 are detachably provided on the side of the rotating mechanism 110 to receive and store ingredients. In a specific embodiment, on one side of the rotating mechanism 110 configured as a hexagonal column, two sets of small auxiliary ingredient storage boxes 120 are stacked and mounted side by side for holding auxiliary materials, such as onions, ginger, and garlic, peppers, etc., each column includes 5 stacked auxiliary ingredient storage boxes 120. A set of 4 stacked storage boxes 120 are respectively mounted on the other five sides of the hexagonal column for holding main ingredients such as meat and vegetables.

Those skilled in the art can foresee that the number and stacking manner of the storage box 120 and the auxiliary material storage box 120 can be adjusted according to actual needs. For example, in some embodiments, the same ingredients can be placed in the same group of stacked storage boxes 120. In other embodiments, different ingredients can be placed in the same group of stacked storage boxes 120, for example, each of the ingredients can be stored in the corresponding storage box 120 from bottom to top according to the order of the dishes to be cooked. Ingredients needed for dishes.

The shape of the rotating mechanism 110 is not limited to a hexagonal column, and may also have other shapes, such as a cylinder, a polygonal column (such as a triangular column, a quadrangular column, etc.), or other regular or irregular shapes. The number of layers of each group of auxiliary ingredient storage boxes 120 and storage boxes 120 carried on the side of the rotating mechanism 110 is not limited to the number shown in FIG. 2, and more or fewer layers, such as one layer, two layers, three, four, five, six, etc.

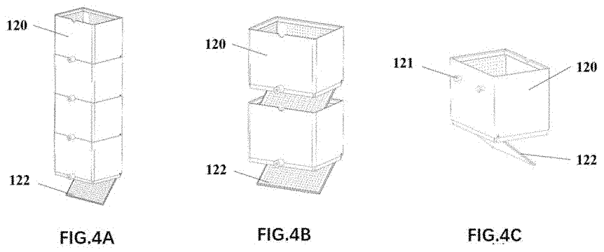

In the embodiment shown in FIG. 2, the side of the rotating mechanism 110 is provided with a substantially drop-shaped card slot 111, and the side wall of the storage box 120 has a matching protrusion 121 (FIG. 4C). 121 is engaged into the card slot, so that the storage box 120 is detachably mounted to the side of the rotating mechanism 110. The protrusion 121 can take any suitable shape, such as a cylindrical pin with a thickened free end, a polygonal column pin, etc. as shown in FIG. 4C. Of course, the shape of the slot 111 and the protrusion 121 can also have other deformations. For example, the card slot 111 can be set as an elongated slot extending substantially parallel to the axis of the rotating mechanism 110, and the protrusion 121 on the back side of the storage box 120 can be fitted into the elongated slot, thereby fixing the storage box 120 on the side of the rotating mechanism 110.

The rotating mechanism 110 can be driven to rotate by a motor (not shown in the figure), so as to rotate the storage box 120 that stores the required ingredient from a non-feeding position deviated from the feeding port 140 to a feeding position aligned with the feeding port 140, so the ingredients stored therein are fed into the cooking unit 200 through the feeding port 140. In some embodiments, the rotating mechanism 110 is driven by a stepping motor, and the stepping motor can precisely control the rotation angle of the rotating mechanism 110. The controller of the cooking device 10 may be in communication with a stepping motor, and control the stepping motor to rotate the rotating mechanism 110 to a desired position, and memorize the position. Furthermore, in some embodiments, the controller can determine the rotation of the rotating mechanism 110 according to the stored ingredients contained in each storage box 120 and the auxiliary materials contained in the auxiliary material storage box 120 according to the principle of proximity. Direction (clockwise or counterclockwise) and angle of rotation, so as to use the least time to rotate the storage box 120/accessory storage box 120 that stores the required ingredients to the top of the feeding port 140 (that is, the feeding position) to improve operation effectiveness.

4A-4C show schematic diagrams of the storage box 120 according to some embodiments of the present application. As shown in FIG. 4A, the storage boxes 120 are stacked vertically. As shown in FIG. 4B, the bottom edge of the storage box 120 slightly shrinks inwardly to form a constricted neck portion. The size and shape of the constricted neck portion is suitable for being used by another storage box 120 immediately below the storage box 120. The top edge is received, so that the stacked storage boxes 120 can maintain their relative positions in the horizontal direction. As shown in FIG. 4C, the storage box 120 is provided with a protrusion 121 on the side wall attached to the rotating mechanism 110, and the protrusion 121 is configured as a cylindrical pin having a substantially T-shaped longitudinal section.

In some embodiments, the storage box 120 can be made of any material suitable for holding ingredients, such as metal, plastic, ceramic, glass, or a combination thereof. In some embodiments, the storage box 120 may be made of a transparent material (for example, transparent plastic, glass). A partition 122 is provided at the bottom of the storage box 120 to releasably support the food stored in the storage box 120. The partition 122 can be made of the same or different materials as the storage box 120, such as metal, plastic, ceramics, glass or a combination thereof. In some embodiments, the partition 122 may be made of a transparent material (for example, transparent plastic, glass). In some embodiments, the inner surface of the storage box 120 contacting the ingredient and the upper surface of the partition 122 may be provided with a number of small protrusions to prevent the ingredient from sticking to these surfaces. The small protrusions can be configured in any suitable shape, such as hemispherical, boss-shaped, pyramid-shaped, and the like.

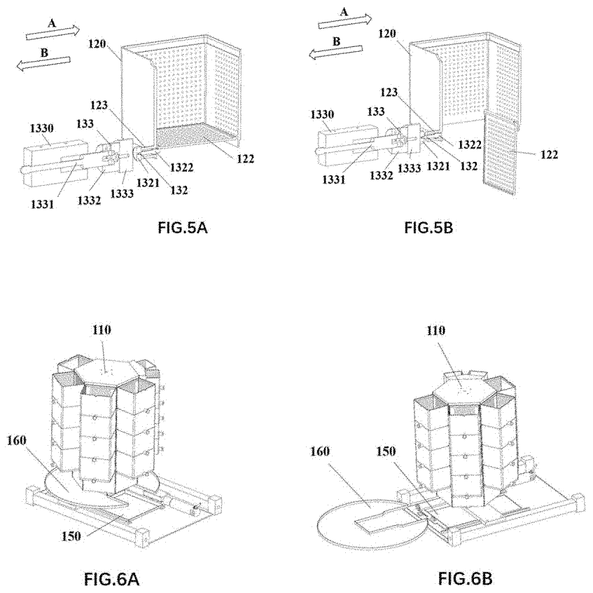

In the embodiment shown in FIGS. 4A-4C, one end of the partition 122 is hinged to the bottom of the storage box 120, for example, to the bottom of the side wall of the storage box 120 close to the rotating mechanism 110, and the partition 122 may be around a hinge axis. Pivot. The free end of the partition 122 can be supported by the partition support member 132 (FIG. 5A) so that the partition 122 extends substantially horizontally, that is, in a blocking position that prevents the food from falling. At this time, the partition 122 can support the storage box 120. Ingredients. When the partition support member 132 is moved and no longer supports the free end of the partition 122, the partition 122 pivots downwards to the release position due to gravity, thereby allowing the food stored in the storage box 120 to be removed from the storage box. The box 120 falls. In other embodiments, the partition 122 can also be connected to the storage box 120 in other ways and switch between the release position and the blocking position in other motions. For example, a sliding rail may be provided at the bottom of the storage box 120, and the partition 122 can be drawn out and pushed into the storage box 120 by translation along the sliding rail.

As shown in FIG. 4B, when the partition 122 moves to the release position, the free end of the partition 122 is a certain distance below the bottom of the storage box 120. In order to avoid the free end of the partition 122 of the lowermost storage box 120 in the release position from obstructing the rotation of the rotating mechanism 110, the storage box 120 may be lifted as a whole, so that the partition 122 of the lowermost storage box 120 is being released. When the free end is slightly higher than the feeding port 140.

In some embodiments, a hollow cylindrical constrictor (not shown in the figure) may be provided under the bottom storage box 120 to guide the falling direction of the food and limit the range of the food, thereby reducing There is a possibility that the food may spill out of the feeding port 140. The size and shape of the top of the constrictor is set to receive the storage box 120, and the height of the constrictor is set to receive the partition 122 when the partition 122 of the storage box 120 adjacent to the constrictor is released.

13A-13B show schematic diagrams of a storage box 120′ according to a modification of the present application. As shown in FIG. 13A, a plurality of (for example, four) storage bins 120′ at the same height are configured as an integrated storage box 124. The center of the integrated storage box 124 formed by the four storage bins 120′ can be provided with a hole 127 to match the rotating mechanism 110. The integrated storage box 124 can also be slid as a whole into a holding device, with the holding device connecting to the rotating mechanism through a shaft as rotation axis. The bottom of the storage bin 120 each has a partition 122 that can be opened separately. In some embodiments, as shown in FIG. 13A, the four storage bins include two larger storage bins 120′ and two smaller storage bins 120′, each of which holds different ingredients. The rest of the configuration of the storage bin 120′ of this modification (such as manufacturing materials, surface protrusions, and partitions 122 matching the storage box 120, etc.) are similar to the foregoing embodiment, and will not be repeated here. By constructing the storage box 124 as an integrated storage box, multiple (for example, four) storage bins 120′ can be loaded on the rotating mechanism 110 at one time. This design is highly efficient in holding and organizing food ingredient more quickly and orderly, for example, the integrated storage box formed by a plurality of storage bins 120′ can hold all the ingredients for one dish.

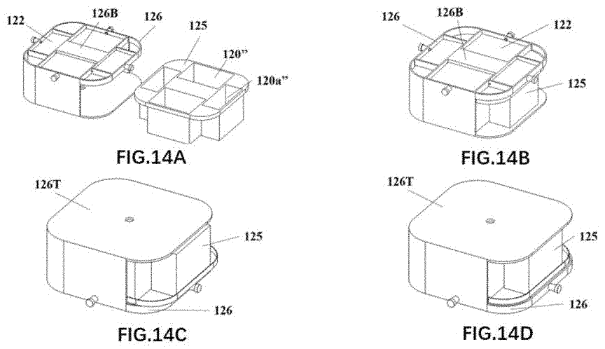

14A-14D show schematic diagrams of an integrated storage box 125 and a storage box holding device 126 for receiving the integrated storage box 125 according to another modification of the present application. The integrated storage box 125 includes at least two ingredient bins 120″ for storing ingredients. For example, in FIG. 14A, the integrated storage box 125 includes two larger ingredient bins 120″ and two smaller ingredient bins 120″. In the state where the storage box holding device 126 is turned over, the integrated storage box 125 can slide relative to the top 126T of the storage box holding device 126 to be loaded into the storage box holding device 126, so the storage box holding device 126 can receive the integrated storage box 125 detachably. The bottom 126B of the storage box holding device 126 is provided with a partition 122 corresponding to the ingredient bin 120″ of the integrated storage box 125. When the integrated storage box 125 is installed in the storage box holding device 126, the opening of the ingredient bin 120″ faces and is aligned with the corresponding partition 122, and the partition 122 can be operated separately to drop the corresponding ingredient in bin 120″ into the cooking unit.

The integrated storage box 125 can be pre-filled with food ingredient, and its opening can be plastic-sealed for storage and transportation. Accordingly, before inserting the integrated storage box 125 into the storage box holding device 126, it is necessary to tear off the sealing film. The storage box holding device 126 is detachably mounted to the rotating mechanism 110. When the integrated storage box 125 needs to be loaded, as shown in FIG. 14A, the storage box holding device 126 removed from the rotating mechanism 110 is first turned over so that the bottom 126B of the storage box holding device 126 faces upward. Then, as shown in FIG. 14B, the integrated storage box 125 with the opening facing upward is slid relative to the top 126T of the storage box holding device 126 to load it into the storage box holding device 126, and then the integrated storage box 125 and the storage box holding device 126 is turned over together to reach the state shown in FIG. 14D. At this time, the food in the integrated storage box 125 is supported by the partition 122 of the storage box holding device 126; now the storage box 125 and the holding device 126 in the combined state can be mounted on the rotating mechanism 110 together. The storage box holding device 126 can be driven by the rotating mechanism 110 to rotate around the axis of rotation, so that a predetermined bin 120″ in the integrated storage box 125 is rotated from the non-feeding position deviated from the feeding port 140 to the feeding position aligned with the feeding port 140, and the feeding operation is performed by operating the partition 122. The remaining settings of the integrated storage box 125 of this modification (such as manufacturing materials, surface bumps and the partition 122 matched with the storage box 125, etc.) is similar to the storage box 120 in the foregoing embodiment, and will not be repeated here. With this arrangement, the integrated storage box 125 can be pre-packaged and provided by a third party, sparing the equipment user the burden of weighing and loading the ingredient into the storage bins. The integrated storage box 125 may be disposable to prevent contamination of ingredients.

Returning to FIG. 2, the food dispensing device 100 further includes a partition activating device 130 for urging the partition 122 to move from the blocking position to the releasing position. The partition actuating device 130 includes a partition support member 132 provided at the bottom of the storage box 120 and a driving member 133 that can be combined with the partition support 132 and actuate the partition support 132. The partition support member 132 is configured to be switchable between a first position (FIG. 5A) for supporting the free end of the partition 122 and a second position (FIG. 5B) for releasing the free end of the partition 122. The driving member 133 is configured to drive the partition support member 132 to move from the first position to the second position. The partition actuating device 130 may further include a guide rail 131 for guiding the vertical movement of the driving member 133. The guide rail 131 is arranged substantially parallel to the axis of the rotating mechanism 110 in the vertical direction, and the driving member 133 can move up and down along the guide rail 131.

FIG. 5A and FIG. 5B respectively show cross-sectional views of the partition support member 132 and the driving member 133 when they have not been coupled together and when they have been coupled together. In FIG. 5A, the partition 122 is in the blocking position; and in FIG. 5B, the partition 122 is in the release position.

As shown in FIG. 5A, the driving member 133 includes a sliding part 1330 that can move along the guide rail 131, a rod-shaped member 1331 that can extend and contract with the sliding part 1330, a fastener 1332, and an electromagnet 1333. The sliding part 1330 is mechanically matched with the guide rail 131 and coupled to the motor, and can be driven by the motor to slide up and down along the guide rail 131. The rod-shaped member 1331 can expand and contract to move toward or away from the rotation mechanism 110.

In some embodiments, a first elastic member (such as a compression spring, not shown in the figure) is connected between the rod-shaped member 1331 and the sliding portion 1330, and the first elastic member applies a bias toward the rotating mechanism 110 to the rod-shaped member 1331. With force, the rod-shaped member 1331 is moved toward the rotating mechanism 110 to a position close to the partition support member 132 (FIG. 5B). The sliding part 1330 and the rod-shaped member 1331 may be configured as a push-pull electromagnet, that is, one of the sliding part 1330 and the rod-shaped member 1331 is configured as an electromagnet, and the other is configured with magnetic permeability. When the electromagnet is energized, the magnetic force between the sliding portion 1330 and the rod-shaped member 1331 moves the rod-shaped member 1331 away from the rotation mechanism 110 (FIG. 5A). It should be noted that the connection and relative movement between the rod-shaped member 1331 and the sliding portion 1330 are not limited to this. In other embodiments, the rod-shaped member 1331 can be expanded and contracted by hydraulic, pneumatic, gear-rack, etc. movement.

The fastener 1332 and the electromagnet 1333 are fixedly connected by welding, riveting or other feasible methods. The fastener 1332 surrounds the rod-shaped member 1331, and the inner surface of the fastener 1332 is tightly pressed by a screw, rivet or other locking method The outer surface of the rod-shaped member 1331 connects the fastener 1332 with the rod-shaped member 1331 so that the fastener 1332 and the electromagnet 1333 can move toward or away from the rotating mechanism 110 along with the rod-shaped member 1331. In some embodiments, the fastener 1332 may not be used. Instead, an external thread is provided on the head end of the rod-shaped member 1331, and an internal thread that matches the external thread is provided inside the electromagnet 1333. The fit can make the rod-shaped member 1331 and the electromagnet 1333 directly fixed, and this structure is more compact.

The partition support member 132 is connected to the storage box 120 through a second elastic member. Specifically, referring to FIG. 5A, the partition support member 132 includes a magnetically conductive member 1321 and a pin 1322. The magnetically conductive member 1321 and the pin 1322 are mechanically connected. The pin 1322 is slidably disposed in the flange 123 at the bottom of the storage box 120. Two elastic members (such as a compression spring, not shown in the figure) are also arranged in the flange 123, and apply a biasing force to the plug, so that the plug 1322 is maintained at the first position of the free end of the support partition 122, thereby supporting the partition. The plate 122 is in a blocking position that blocks the falling of ingredients.

Further, as shown in FIG. 5B, when the rod-shaped member 1331 of the driving member 133 moves in the direction of arrow A in the figure, the electromagnet 1333 at the front end of the driving member 133 is driven to move toward the partition support member 132 and energize the electromagnet 1333. The electromagnet 1333 and the magnetically conductive member 1321 at the rear end of the plug 1322 are magnetically connected. Immediately afterwards, the rod-shaped member 1331 retracts slightly, driving the electromagnet 1333 and the magnetic conductive member 1321 to move in the direction of arrow B, and then driving the bolt 1322 to overcome the biasing force of the second elastic member to move backwards, thereby causing the bolt 1322 to move backwards. The end no longer supports the free end of the partition 122, and the partition 122 therefore pivots to the release position about its hinge axis under the action of gravity. After completing the operation of opening the partition 122, the electromagnet 1333 can be powered off, the electromagnet 1333 is disconnected from the magnetic conductive member 1321, and the rod-shaped member 1331 is moved away from the rotating mechanism 110 to its initial position, waiting for the next time operating.

In other embodiments, the driving member 133 and the partition support member 132 may work with each other through a mechanical structure. Specifically, the front end of the driving member 133 has a protrusion, and the partition support member 132 has a groove matched with the protrusion. When the protrusion at the front end of the driving member 133 extends to the groove, the protrusion and the groove can be combined and locked by a small rotation or translation, and then the driving member 133 drives the partition support member 132 to move backward, and drives the latch to move to the second position where the partition 122 is allowed to fall. After the partition 122 is released, the protrusion can move along the opposite direction to release the lock with the groove, and the driving member 133 correspondingly returns to its initial position for subsequent operations. It is foreseeable that, in some embodiments, a protrusion may also be provided on the partition support member 132, and the front end of the driving member 133 is provided with a groove that is locked in combination with the protrusion.

In other embodiments, one of the driving member 133 and the partition support member 132 may have a hook portion, and the other one may have a pull loop that cooperates with the hook portion. The fit of the hook portion and the pull ring is similar to the fit of the aforementioned groove and protrusion, and will not be repeated here.

In some embodiments, the partition support member 132 may be arranged to be hinged to the bottom of the storage box 120, and the driving member 133 drives the partition support member 132 to pivot to release the support for the free end of the partition 122.

In some embodiments, the driving member 133 is driven by a motor to move along the guide rail 131, preferably by a stepping motor to move along the guide rail 131. The stepping motor may be communicatively connected with the controller to accurately control the stroke, so as to accurately move the driving member 133 to a position flush with the partition support member 132 to be operated. The controller can also determine and memorize which partition support members 132 have been activated by the driving member 133 according to the stroke of the stepping motor, so as to determine which ingredients in the storage box 120 have been released into the cooking unit.

In other embodiments, sensors corresponding to the maximum number of layers of storage boxes that can be set on the rotating mechanism 100 are provided on the guide rail 131, and the sensors intervals are arranged in such way so as to correspond to the heights of the partition supports 122 of the storage boxes 120 of each layer. With this arrangement, when the driving member 133 moves close to the height of the corresponding partition support member 122, the sensor senses the driving member 133 and sends a signal to the controller. The controller sends an instruction to immediately stop the driving member 133 from moving up and down. In this way, the driving member 133 can be moved to a position flush with the partition support member 132 to be operated as required.

In some embodiments, between the rotating mechanism 110 and the cooking unit 200 below, a baffle 150 is also provided. The baffle 150 is provided on a track parallel to the table top and is driven to move along the track between the sheltered position and the open position. FIG. 6A shows a schematic diagram of the baffle 150 and the receiving tray 160 according to an embodiment of the present application, where the baffle 150 is in the shielding position, and the receiving tray 160 is in an installed state. 6B shows a schematic diagram of the baffle 150 and the receiving tray according to an embodiment of the present application, wherein the baffle 150 is in an open position and the receiving tray 160 is in a disassembled state.

As shown in FIG. 6A, the baffle 150 is disposed between the rotating mechanism 110 and the cooking unit 200. The baffle 150 is substantially rectangular, and may also be an ellipse or a circle. The area of the baffle 150 is greater than or equal to the area of the feeding port 140 so as to completely block the feeding port 140, so as to isolate the spaces of both sides. The baffle 150 can be driven to move between a shielding position that shields the feeding port 140 and an open position that exposes the feeding port 140. Specifically, when the feeding operation is not performed, the baffle 150 is in a shielding position to prevent oil fume generated in the cooking unit 200 from overflowing and spreading through the feeding port 140 during cooking. When the feeding operation is required, according to the instructions of the controller, as described above, the baffle 150 moves to the open position to expose the feeding port 140 (as shown in FIG. 6B); the rotating mechanism 110 makes the corresponding storage boxes 120, 120′ Or the material pocket 120″ rotates to the feeding position aligned with the feeding port 140; the driving member 133 moves to approach the corresponding partition support member 132, and then the partition support member 132 is switched to the second position to move the partition 122 to release Position, the ingredient falls from the feeding port 140 into the cooking unit 200. After the feeding operation is completed, the baffle 150 moves back to the shielding position to block oil smoke.

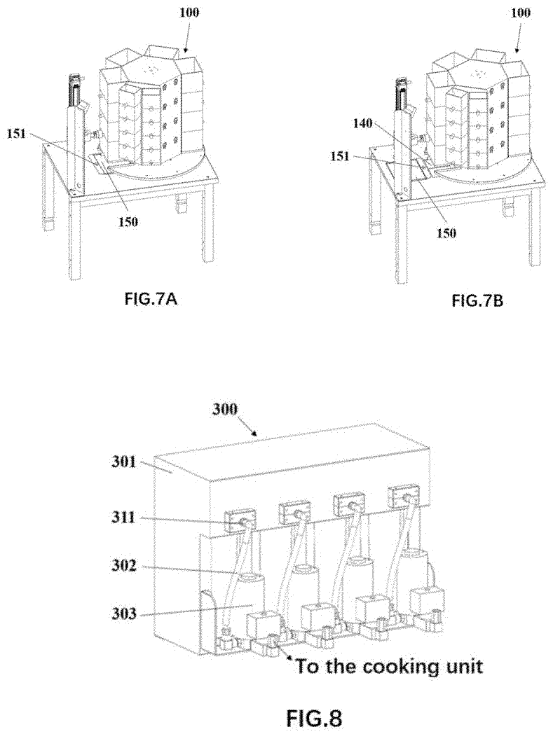

In other embodiments, the baffle 150 rotates in a plane parallel to the table surface to move between the shielding position and the open position. FIG. 7A-7B show schematic diagrams of the baffle 150 according to some embodiments of the present application, wherein the baffle 150 in FIG. 7A is in the shielding position, and the baffle 150 in FIG. 7B is in the open position.

As shown in FIGS. 7A-7B, the baffle 150 is set on the table, and its area and shape can cover the feeding port 140. One end of the baffle 150 is fixed by a shaft 151 perpendicularly passing through the table, and the baffle 150 can be driven to pivot about the shaft. In FIG. 7A, the baffle 150 is in the shielding position, shielding the feeding port 140 to prevent oil smoke from spreading upward. In FIG. 7B, the baffle 150 has been rotated 180 degrees around the axis 151 relative to the position in FIG. 7A and is in an open position. At this time, the feeding port 140 is exposed, and the feeding operation can be performed. By setting the baffle 150 to rotate in the plane where the table is located, there is no need to provide a rail structure for guiding the baffle 150 to slide between the cooking unit 200 and the food feeding device 100, and the structure is relatively simple and easy to clean.

In other embodiments, the baffle 150 may be configured to rotate around an axis parallel to the table surface to move between the shielding position and the open position.

Generally speaking, the food ingredient in the storage box 120, 120′ or the feed bin 120″ is usually not completely dry, and the liquid sauces in the storage box 120, storage bin 120′ or the storage bin 120″ will inevitably pass through the gap between the partition 122 and the inner wall of the storage box or the ingredient bin and drip downward. In addition to liquids, there may also be ingredient debris falling from the gap. If these ingredient scraps and liquid sauce drip directly onto the countertop below, it will contaminate the countertop and make it inconvenient to clean. It may also affect the normal operation of the cooking device. In addition, liquid drippings and food residues that cannot be cleaned in time may deteriorate, which may affect the cleanliness and tidiness of the operating environment, and may even cause food safety issues.

In response to these problems, referring to FIGS. 6A-7B, a detachable receiving tray 160 is also provided at the bottom of the rotating mechanism 110. The receiving tray 160 is configured to collect liquid dripping or crushed ingredients debris from the storage box 120 in the non-feeding position. The receiving tray 160 is generally circular and has an opening at a position corresponding to the feeding port 140 to allow the food to pass smoothly. However, the receiving tray 160 may also be an elliptical, polygonal, or rectangular shape. The receiving tray 160 can cover all the storage boxes 120, 120′ in the non-feeding position, and the projected area of the ingredient bin 120″ on it, so that the receiving tray 160 can accept all the storage boxes 120, 120′ in the non-feeding position, The liquid dripping from the ingredient bin 120″. The bottom of the rotating mechanism 110 may be provided with a long guide groove, and the inner side of the receiving tray 160 is provided with a strip-shaped protrusion capable of sliding into the long guide groove. In other embodiments, a plurality of protrusions are provided at the bottom of the rotating mechanism 110 to support the receiving tray 160. As shown in FIG. 6B, the receiving tray 160 can be manually drawn out, and detached from the rotating mechanism 110 and cleaned, the receiving tray 160 can also be quickly reset after cleaning.

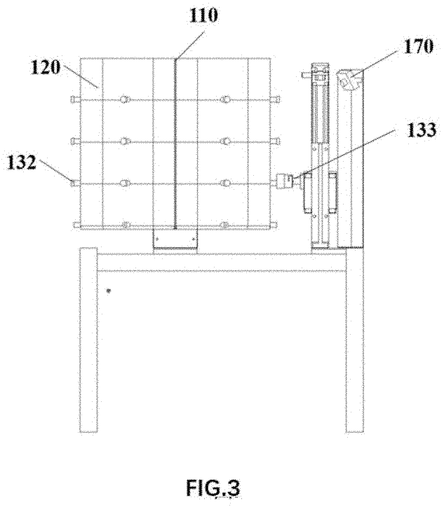

In some embodiments, the cooking device 10 may further include an ingredient identification device 170. FIG. 3 exemplarily shows a side view of the ingredient feeding device 100 and the ingredient identification device 170 according to an embodiment of the present application.

As shown in FIG. 3, the ingredient identification device 170 is installed on the table and used to identify the food stored in the storage box 120. After the ingredient identification device 170 obtains the pictures of the food stored in the storage boxes 120, 120′ and the ingredient bin 120″, it transmits the pictures of the food to the controller through a wired or wireless connection. The controller uses an image recognition algorithm to identify the food, and the identified ingredient is associated with the storage box 120, 120′, and ingredient bin 120″ storing the ingredient. In some embodiments, the image recognition algorithm used may be an algorithm based on a convolutional neural network. In some embodiments, the food recognition device 170 includes an image recognition device, such as a wide-angle camera. The storage boxes or bins 120, 120′, and 120″ can be made of transparent materials (such as transparent plastic, glass). Therefore, the wide-angle camera can obtain pictures of multiple sets of stacked storage boxes or bins 120, 120′, and the 120″ in front of it. The pictures containing the ingredients in multiple storage boxes are sent to the controller to be recognized together by the controller, thereby improving the recognition efficiency. In order to ensure that the ingredients in the multiple storage boxes or bins 120, 120′, and 120″ can be identified as much as possible. In some embodiments, the ingredient identification device 170 is arranged at the front side of the rotating mechanism 110, and the height is flush with the top of the rotating mechanism. This avoids the blocking of the content in the storage box or bin 120, 120′ or 120″, by the lower stacks of storage box or bin 120,120′ or 120″, when looking up from below, so as to improve the recognition accuracy.

In a specific embodiment, the controller may number the storage boxes or ingredient bins 120, 120′, 120″ and memorize their positions and the corresponding relationship with the ingredients. For example, in the embodiment shown in FIG. 2, according to their positions at different sides of the hexagonal column of the rotating mechanism 110, and the stacking boxes on each side can be numbered A, B, C, D, E, F, F′. Among them, A-E is the storage box 120 for storing the main ingredient, installed on one side of the rotating mechanism 110, while F and F′ are auxiliary ingredient storage boxes, installed on the remaining side of the rotating mechanism 110. Then the ingredients are stored from bottom to top according to the stacking order of the storage boxes 120, and are respectively numbered A1, A2, A3, A4, B1, . . . F′5. Through the identification of the ingredient identification device 170, the controller can obtain the relationship between the food ingredient and the corresponding storage box 120, for example, the storage box A1-A4 contains diced chicken, storage boxes B1-B4 contain peanuts, and storage boxes F1-F5 contain peppers.

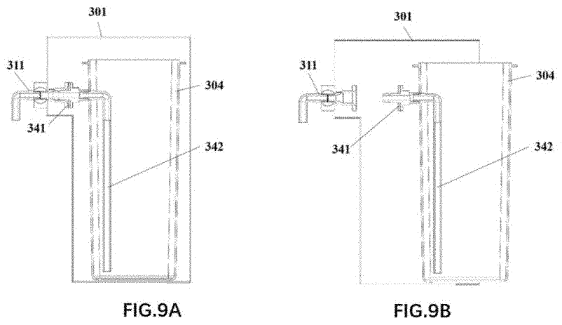

FIG. 8 shows a schematic diagram of a liquid ingredient feeding device 300 according to an embodiment of the present application. As shown in FIG. 8, the liquid ingredient feeding device 300 includes a housing 301, a feeding pipe 302, and a pump member 303. The liquid feed device 300 also includes a liquid feed tank 304 (shown in FIGS. 9A-9B). The housing 301 is provided with a first connector 311, and the first connector 311 can be in fluid communication with a second connector 341 provided on the liquid tank 304 (FIG. 9A-9B) located inside the housing 301; the first connector 311 is also in fluid communication with the feeding pipe 302, the pump member 303 is connected to the feeding pipe 302, and the pump member 303 is configured to apply pressure (for example, negative pressure) to the feeding pipe 302, so that the liquid ingredient in the feeding pipe 302 flows and finally leads to the cooking unit 200. In some embodiments, the liquid ingredient is finally sprayed into the cooking unit 200 through the spray head.

FIG. 9A-9B respectively exemplarily show the connection state and the disassembly state of the liquid tank 304 in the housing 301 of the liquid ingredient feeding device 300 shown in FIG. 8. In some embodiments, the liquid tank 304 is located inside the housing 301 and is used to contain liquid ingredients. A second joint 341 is provided on the liquid tank 304, which is connected with a hose 342, and the hose 342 extends to the bottom of the liquid tank 304 for sucking the liquid ingredient in the tank. The second joint 341 is detachably connected to the first joint 311 in the housing 301. FIG. 9A shows that the liquid tank 304 is in fluid communication with the first joint 311 through the second joint 341, and FIG. 9B shows the situation where liquid tank 304 is disconnected from the first joint 311.

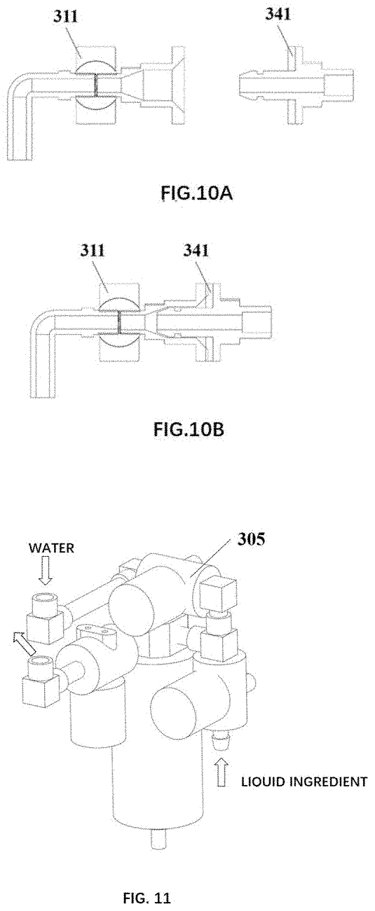

FIG. 10A-10B respectively show enlarged schematic diagrams of the first joint 311 and the second joint 341 shown in FIG. 9A in a connected state and a disconnected state.

As shown in FIGS. 10A-10B, the second connector 341 is configured as a tapered male connector, and the first connector 311 is configured as a tapered female connector. The second connector 341 can be pushed into the first connector 311 and matched with the first connector 311, so that the liquid ingredient is delivered from the liquid ingredient tank 304 to the cooking unit 200 through the hose 342, the second joint 341, the first joint 311, and the feeding pipe 302 in sequence. In some embodiments, the second joint 341 may be a tapered female joint, and the first joint 311 may be a tapered male joint that matches the second joint 341. The design of this tapered joint allows the second joint 341 and the first joint 311 to be easily connected and disconnected under the condition of ensuring the seal.

With the above arrangement, the liquid tank 304 can be easily disassembled to facilitate refilling the liquid ingredient, replacing the liquid ingredient tank, or cleaning the liquid ingredient tank. In some embodiments, after the liquid tank 304 is cleaned, clean water is filled therein, and the second joint 341 is connected to the first joint 311, so that the pipeline and cooking unit 200 can be cleaned by flowing clean water through the entire pipeline.

In some embodiments, the pipeline can be cleaned by setting a liquid ingredient supply pipeline switching member to introduce clean water from the water source. FIG. 11 shows a schematic diagram of a liquid ingredient supply pipeline switching member 305 according to some embodiments of the present application. The liquid ingredient supply pipeline switching member 305 has two input pipelines, one of which is connected to the feeding pipeline 302. Another input pipeline is connected to a water source, and the liquid ingredient supply pipeline switching member 305 also has an output pipeline output to the cooking unit 200. The liquid ingredient supply pipe switching member 305 can selectively connect either the feeding pipe 302 or the water source to the output pipe, according to the controller command, so that the cooking unit 200 can selectively communicate with the liquid ingredient tank 304 or the water source. Specifically, when the liquid ingredient needs to be transported, the liquid ingredient supply pipe switching member 305 connects the feeding pipe 302 with the output pipe, so that the liquid ingredient tank 304 is in fluid communication with the cooking unit 200, so the liquid in the liquid ingredient tank 304 can be transported to the cooking unit 200. When the pipeline and the cooking unit need to be cleaned, the liquid ingredient supply pipeline switching member 305 connects the water source with the output pipeline, so that clean water flows through the entire pipeline for cleaning.

In some embodiments, the cooking device further includes a communication module that can communicate with a server to receive a recipe from the server.

In some embodiments, the controller of the cooking device is configured to control the operation of the cooking device according to the cooking program received from the server. In some embodiments, the controller includes a processor, a memory, and an input/output interface.

In some embodiments, the cooking equipment also has a cleaning device for cleaning the ingredient delivery device, the cooking unit, and the liquid ingredient injection device. In some embodiments, the cleaning device is a CIP cleaning device.

In some embodiments, the cooking device further includes a waste collection device. The waste collection device collects waste generated during cooking and cleaning, such as waste water, waste oil, or waste residue, in a designated container, such as an oil-water separator.

In some embodiments, the cooking device further has a disinfecting device for disinfecting the cooking device. In some embodiments, the disinfection device is an ultraviolet disinfection device. In other embodiments, the disinfection device is a steam disinfection device.

In some embodiments, the cooking device also has a safety interlock device. In some embodiments, the safety interlock device includes a temperature sensor, a pressure sensor, and a smoke sensor, and the safety interlock device causes the cooking appliance to emergency stop when the reading of the temperature sensor, the pressure sensor, and the smoke sensor exceeds a set value.

In some embodiments, the above-mentioned cooking device also has a human-computer interaction interface, which is communicatively connected with the controller of the cooking device, and the user can input food information through the human-computer interaction interface, consult the real-time menu, and select Cooking procedures, adjusting cooking parameters, etc. In some embodiments, the above-mentioned human-computer interaction behavior may also be implemented remotely from wireless communication, for example, through a remote control interface, such as a smart phone application, to give cooking instructions. In some embodiments, the above-mentioned human-machine interface may be voice-based, including voice prompts and voice confirmations. The above-mentioned voice service may also be based on artificial intelligence, which can communicate with users intelligently like people based on user habits. In some embodiments, the aforementioned human-machine interface may be based on VR (Virtual Reality), AR (Enhanced Reality), or MR (Mixed Reality).

In some embodiments, the menu database of the above-mentioned cooking device also has a personalization module, which can record the food preferences of a diner user about his or her taste preference of one or more dishes, so that the user of the cooking device can custom-made the dishes for that diner. The above-mentioned cooking device can also recommend a corresponding menu based on the list of dishes cooked for the diner in the past using the cooking device and the diner's historical ordering preferences. In some embodiments, the cooking device can also be connected to the Internet to update recipes through a cloud server, and read log data on various operating parameters of the cooking device for fault prevention and troubleshooting.

In some embodiments, the menu database of the cooking device also has a log module, which can automatically record log information such as execution parameters at each moment of the cooking process. In some embodiments, the human-computer interaction interface of the cooking device has an interface for a dish developer. The dish developer can manually operate the cooking unit in real time and change the parameters of the unit operation in real time. This series of operations can be recorded and restored by the log module, which is convenient for dish developers to conduct dish research and development. In some embodiments, the aforementioned log module can also analyze log information and provide related data services. The analysis and data services include, but are not limited to, operational audits, nutrition trend analysis, seasonal menu analysis, and statistical analysis of taste preferences in different regions, tracking of the execution status of Traditional Chinese Medicine diet therapy, etc. In some embodiments, the menu database may also include general nutritional information and user-specific nutritional information, such as calorie and protein intake. There is a nutrition menu set according to nutrition for users who participate in specific nutrition activities.

In some embodiments, the above-mentioned cooking equipment has a battery system to provide the power required for the operation of the cooking equipment, and can be charged under the current power distribution capacity of the user's kitchen, avoiding being limited by the user's kitchen power capacity when such power capacity is less than the rated power of the cooking equipment.

In some embodiments, the above-mentioned cooking equipment can be installed on a mobile vehicle, which can save kitchen space. Cooking operations can be performed while the vehicle is in transportation, so as to save food service time. The on-board cooking machine can be powered by batteries or gasoline and diesel generators.

In some embodiments, the above-mentioned cooking equipment can be used in an autonomous restaurant (including chain restaurants, corporate canteens, etc.) to automatically cook and provide all dishes. The menu can be provided by the restaurant, or can be selected by the restaurant guests from the optional menu provided by the cloud database according to the restaurant's current inventory of the restaurant's ingredients, so as to enrich the guests' choice of dishes based on the existing ingredients.

In some embodiments, the above-mentioned cooking device can also be used in the home, and remote cooking control can be realized through the cooking device. Similarly, the cooking equipment can also be used for remote chef services. Through the chefs operation and parameter adjustment, personalized dishes can be made remotely through the cooking equipment. In some embodiments, the above-mentioned cooking equipment can also be used as a self-service vending machine placed in a hotel or office building, and the cooking equipment can provide freshly cooked dishes on-spot. In some embodiments, a public kitchen can also be formed by multiple cooking equipment, and users can rent the cooking equipment for a period of time to cook their own or purchased ingredients from the public kitchen. The cooking equipment in the public kitchen can be operated by a dedicated person or by the end user.

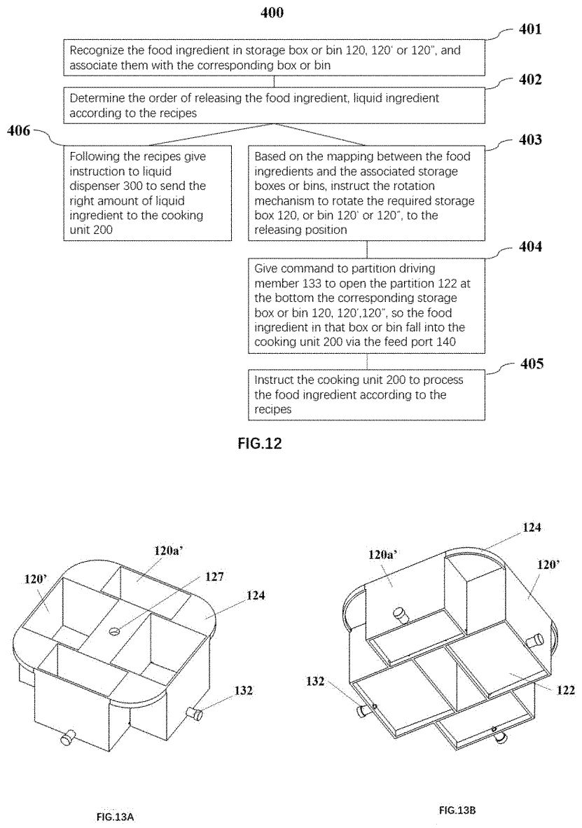

FIG. 12 shows a flow chart of the controller of the cooking device 10 according to the embodiment of the present application to cook according to the recipe. According to FIG. 12, the cooking process 400 includes the following steps:

In step 401, the food ingredient stored in the storage box or bin 120, 120′ or 120″ is identified, and the food ingredient is associated with the corresponding storage box or bin 120, 120′, 120″. In some embodiments, as described above, the food ingredient can be identified by the food ingredient identification device 170, such as a wide-angle camera, and then associated with the storage box or bin 120, 120′, 120″ according to the state of the rotating mechanism 110. In step 402, the controller determines the order by which the ingredients to be released according to the acquired recipe; in step 403, the controller determines the ingredients, placed in 120, 120′, and 120 “, to be released and instruct the rotating mechanism 110 to rotate the storage boxes and bins 120, 120′ and 120” corresponding to the desired food ingredient to the feeding position; in step 404, the controller instructs the partition actuator 130 to open the corresponding partition 122 of the storage box or bin 120,120′ and 120″ to allow the ingredients to fall into the cooking unit 200 through the feeding port 140; in step 405, the controller instructs the cooking unit to process the ingredients according to the recipe; in step 406, control The device instructs the liquid ingredient feeding device 300 to deliver the liquid ingredient to the cooking unit 200 according to the recipe instructions. Step 406 can be performed simultaneously with step 403, or can be performed before or after step 403. The above steps can be repeated.

For example, in the specific embodiment shown in FIG. 2, the cooking device 10 can be used to make Kung Pao chicken. Before starting to make, the ingredient identification device 170 identifies the food ingredient, and the controller associates the identified food ingredient with the storage box 120, for example, the storage boxes A1-A4 contain diced chicken, the storage boxes B1-B4 contain peanuts, and the auxiliary ingredient storage boxes F1-F5 contain peppers. The controller obtains the recipe of Kung Pao Chicken, and determines the required ingredients and the order of releasing them: first stir-fry the chicken, then add the peppers, and finally stir in the peanuts. Next, the controller instructs the liquid ingredient feeding device 300 to deliver oil to the cooking unit 200, and at the same time instructs the rotating mechanism 110 to rotate the storage boxes A1-A4 to the feeding port according to the determined feeding information and the associated information between the food ingredient and the storage box 140, and instruct the partition actuating device 130 to open the partition 122 of the storage box A1, so that a portion of diced chicken falls into the cooking unit 200 through the feeding port 140. After the cooking unit 200 stir-fries the diced chicken, the controller instructs to rotation mechanism 110 to rotate the storage boxes F1-F5 to the feeding opening 140, and instructs the partition actuating device 130 to open the partition 122 of the storage box F1, so that a portion of pepper falls into the cooking unit 200 through the feeding opening 140, and then commands the liquid ingredient feeding device 300 to deliver salt solution and soy sauce to the cooking unit 200, and instructs the cooking unit 200 to stir-fry for a pre-determined time according to the recipes, or until the broth in the cooking unit is thick and dry, as recognized by a camera image and the edge-computing algorithm. After that, the controller instructs the rotating mechanism 110 to rotate the storage boxes B1-B4 to the feeding port 140, and instructs the partition actuator 130 to open the partition 122 of the storage box B1, so that a portion of peanuts passes through the feeding port 140 and is dropped into the cooking unit 200, and then instruct the cooking unit 200 to turn off the heat and stir evenly, and a dish of Kung Pao chicken is done.

Those skilled in the art can understand and implement other changes to the disclosed embodiments by studying the description, the disclosed content, the drawings and the appended claims. In the claims, the word “comprise” does not exclude other elements and steps, and the word “a” and “one” do not exclude plurals. In the actual application of this application, one part of apparatus may perform the functions of multiple technical features cited in the claims. Any captions in the drawing in the claims should not be construed as limiting the scope.

1. A cooking device, characterized in that, the cooking device comprises:
a cooking unit configured to perform cooking processing on ingredients; and
an ingredient feeding device is located above the cooking unit, and the ingredient feeding device and the cooking unit are in communication with each other through a feeding port, and the food ingredient can enter the cooking unit from the ingredient feeding device through the feeding port;
wherein, the ingredient feeding device includes:
a rotating mechanism, which carries with it at least one storage box, the rotating mechanism can be driven to rotate around the axis of rotation, so that a predetermined storage box is rotated from the non-feeding position deviated from the feeding port to the feeding position where the feeding opening is aligned, and a partition is provided at the bottom of the storage box; and
a partition activating device is configured to drive the corresponding partition to move from a blocking position that prevents the ingredient from falling to a release position that allows the ingredient to fall.

2. A cooking device, characterized in that, the cooking device comprises:
a cooking unit configured to perform cooking processing on ingredients; and
an ingredient feeding device is located above the cooking unit, and the ingredient feeding device and the cooking unit are in communication with each other through a feeding port, and the food can enter the cooking unit from the ingredient feeding device through the feeding port;
wherein, the ingredient feeding device includes:
an integrated ingredient storage box, which includes at least two bins for storing ingredients, the bottom of each bin is provided with a corresponding partition;
a storage box holding device, into which the/integrated storage box can slide; when an integrated storage box is loaded into the storage box holding device, the bottom of the bins of the integrated storage box can be aligned with the feeding port below;
a rotating mechanism, the storage box holding device is detachably mounted to the rotating mechanism, and the storage box holding device can be driven by the rotating mechanism to rotate around a rotation axis, so that a predetermined storage box or a predetermined bin of an integrated storage box is rotated from a non-feeding position deviated from the feeding port to a feeding position aligned with the feeding port; and
a partition activating device is configured to drive the corresponding partition to move from a blocking position that prevents the ingredient from falling to a release position that allows the ingredient to fall.

3. The cooking device according to claim 1, wherein the partition is pivotally fixed to the bottom of the storage box.

4. The cooking device according to claim 2, wherein the partitions are pivotally fixed to the bottom of the bins of an integrated storage box.

5. The cooking device according to claim 3, wherein the partition actuating device includes a partition support member, the partition support member is provided at the bottom of the storage box and is configured to be able to be in two positions, first position to support the free end of the partition and the second position where the free end of the partition is released.

6. The cooking device according to claim 5, wherein the partition actuating device further comprises a driving member configured to drive the partition support member to move from the first position to the second position.

7. The cooking device according to claim 5, wherein the partition support member is connected to the storage box or to each of its individual bin by an elastic member, and the elastic member applies the partition support member a biasing force to bias it to be in the first position.

8. The cooking device according to claim 6, wherein the partition actuating device further comprises a guide rail for guiding the movement of the driving member.

9. (canceled)

10. The cooking device according to any claim 6, wherein the driving member comprises an electromagnet, and the partition support member is provided with a magnetic conductive member that can be magnetically combined with the electromagnet.

11. (canceled)

12. The cooking device according to claim 6, wherein one of the driving member and the partition support member has a hook portion, and the other has a pull ring that cooperates with the hook portion.

13. (canceled)

14. (canceled)

15. The cooking device according to claim 1, wherein the rotating mechanism is configured as a polygonal column, and at least one storage box is provided on each side of the polygonal column.

16. (canceled)

17. (canceled)

18. The cooking device according to claim 2, wherein the center of the storage box holding device is provided with a hole matching with the rotating mechanism.

19. (canceled)

20. (canceled)

21. (canceled)

22. The cooking device according to claim 1, wherein a card slot is provided on the side of the rotating mechanism, and a protrusion is provided on the side wall of the storage box, and the protrusion is detachably connected to the card slot.

23. The cooking device according to claim 1, wherein the inner surface of the storage box or the ingredient bins and/or the upper surface of the partition is provided with a number of small protrusions.

24. (canceled)

25. The cooking device according to claim 1, wherein the baffle is configured to linearly move or rotate between the shielding position and the open position.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. The cooking device according to claim 4, wherein the partition actuating device includes a partition support member, the partition support member is provided at the bottom of the storage box and is configured to be able to be in two positions, first position to support the free end of the partition and the second position where the free end of the partition is released.

38. The cooking device according to claim 7, wherein one of the driving member and the partition support member has a hook portion, and the other has a pull ring that cooperates with the hook portion.

39. The cooking device according to claim 8, wherein one of the driving member and the partition support member has a hook portion, and the other has a pull ring that cooperates with the hook portion.

40. The cooking device according to claim 9, wherein one of the driving member and the partition support member has a hook portion, and the other has a pull ring that cooperates with the hook portion.

41. The cooking device according to claim 2, wherein the baffle is configured to linearly move or rotate between the shielding position and the open position.
